(19) United States
(12) Patent Application Publication
(10) Pub. No.: US 2026/0369304 A1
(43) Pub. Date: Nov. 19, 2026

(54) VIDEO PROCESSING METHOD, ELECTRONIC DEVICE, AND STORAGE MEDIUM

(71) Applicant: Lenovo (Beijing) Limited, Beijing (CN)

(72) Inventor: Shuangxin YANG, Beijing (CN)

(21) Appl. No.: 19/341,716

(22) Filed: Sep. 26, 2025

(30) Foreign Application Priority Data
Sep. 27, 2024 (CN) 202411365212.X

(51) Int. Cl. G11B 27/036; G06V 10/52; G06V 20/40; G11B 27/34

(52) U.S. Cl. CPC G11B 27/036; G06V 10/52; G06V 20/46; G11B 27/34

(57) ABSTRACT

The present disclosure provides a video processing method, a video generation method and a device. The video processing method includes obtaining input data, the input data indicating a user's target intention to generate a video, obtaining a resource set from a multimedia library according to the input data, where the resource set includes at least one multimedia data, and the multimedia data includes at least one of the following types: an image type or a video type, generating an index set corresponding to the target intention based on the input data and the resource set, extracting at least one target image corresponding to each piece of index information from the multimedia data in the resource set based on the index information in the index set, and generating a target video based on target images.

### CROSS-REFERENCE TO RELATED APPLICATION

This application claims priority to Chinese Patent Application No. 202411365212.X, filed on Sep. 27, 2024, the content of which is incorporated herein by reference in its entirety.

### TECHNICAL FIELD

The application relates to the field of data processing technology, in particular to a video processing method, a video generation method and a device.

### BACKGROUND

Currently, on electronic devices, a user may mix pictures and videos, add music and motion effects, and get edited videos. However, when using this method, a user is required to first select specific pictures and cut out key clips in the video, so there is a high degree of operational complexity, which affects the user experience.

### SUMMARY

In one aspect, the present disclosure provides a video processing method, and the method includes obtaining input data, the input data indicating a user's target intention to generate a video, obtaining a resource set from a multimedia library according to the input data, where the resource set includes at least one multimedia data, and the multimedia data includes at least one of the following types: an image type or a video type, generating an index set corresponding to the target intention based on the input data and the resource set, extracting at least one target image corresponding to each piece of index information from the multimedia data in the resource set based on the index information in the index set, and generating a target video based on target images.

In another aspect, the present disclosure provides a video generation method, and the method includes obtaining input data, the input data indicating a user's target intention to generate a video; obtaining a resource set from a multimedia library according to the input data, where the resource set includes at least one multimedia data, and the multimedia data includes at least one of the following types: an image type or a video type; and processing the input data and the resource set based at least on a target model to generate a target video, where the target video includes multiple frames of target images that meet the target intention, and the target images are derived from at least one of the following: multimedia data, in the resource set, that matches the target intention, or partial data, in the multimedia data in the resource set, that matches the target intention.

In another aspect, the present disclosure provides an electronic device. The electronic device includes one or more processors and a memory containing a computer program that, when being executable, causes the one or more processors to perform: obtaining input data, the input data indicating a user's target intention to generate a video; obtaining a resource set from a multimedia library according to the input data, the resource set including at least one multimedia data, and the multimedia data including at least one of following types: an image type or a video type; generating an index set corresponding to the target intention based on the input data and the resource set; extracting at least one target image corresponding to each piece of index information from the multimedia data in the resource set based on the index information in the index set; and generating a target video based on target images.

In another aspect, the present disclosure provides a non-transitory computer readable storage medium containing a computer program that, when being executable, causes at least one processor to perform: obtaining input data, the input data indicating a user's target intention to generate a video; obtaining a resource set from a multimedia library according to the input data, the resource set including at least one multimedia data, and the multimedia data including at least one of following types: an image type or a video type; generating an index set corresponding to the target intention based on the input data and the resource set; extracting at least one target image corresponding to each piece of index information from the multimedia data in the resource set based on the index information in the index set; and generating a target video based on target images.

It should be understood that the content described in this section is not intended to identify the key or important features of the embodiments of the present disclosure, nor is it intended to limit the scope of the present disclosure. Other features of the present disclosure will become easily understood through the following brief description of the drawings and the detailed description.

### BRIEF DESCRIPTION OF THE DRAWINGS

In order to more clearly illustrate the technical solutions in the embodiments of the disclosure, the drawings essential for understanding the disclosed embodiments will be briefly described below. Apparently, the drawings described below are merely some embodiments of the disclosure. For a person skilled in the art, other drawings may be obtained based on the provided drawings without making creative efforts.

FIG. 1 is a flowchart of a video processing method, according to an embodiment of the present disclosure;

FIG. 2 is a schematic diagram of an example method of obtaining user input data, according to an embodiment of the present disclosure;

FIG. 3 is a schematic diagram of an example method of obtaining a resource set, according to an embodiment of the present disclosure;

FIG. 4 is a schematic diagram of an example method of obtaining an index set, according to an embodiment of the present disclosure;

FIG. 5 is a schematic diagram of an example method of extracting coarse-grained features and fine-grained features, according to an embodiment of the present disclosure;

FIG. 6 is a schematic diagram of an example method of extracting target images according to index information, according to an embodiment of the present disclosure;

FIG. 7 is a schematic diagram of an example method of stitching target images to generate a target video, according to an embodiment of the present disclosure;

FIG. 8 is a flowchart of another video processing method, according to an embodiment of the present disclosure;

FIG. 9 is a flowchart of a video generation method, according to an embodiment of the present disclosure;

FIG. 10 is a schematic structural diagram of a video processing device, according to an embodiment of the present disclosure;

FIG. 11 is a schematic structural diagram of a video generation device, according to an embodiment of the present disclosure;

FIG. 12 is a schematic structural diagram of an electronic device, according to an embodiment of the present disclosure;

FIG. 13 illustrates an example of multiple video recordings of a celebratory occasion;

FIG. 14 is a schematic diagram of interactive quick video editing based on user intention on a mobile phone, according to an embodiment of the present disclosure;

FIG. 15 is a schematic diagram of an example method of implementing segmented video feature extraction on a mobile phone, according to an embodiment of the present disclosure;

FIG. 16 is a flowchart of a method for interactive video story generation based on coarse-grained features on a mobile phone, according to an embodiment of the present disclosure;

FIG. 17 is a flowchart of a method for generating interactive video stories based on coarse-grained features combined with some fine-grained features on a mobile phone, according to an embodiment of the present disclosure; and

FIG. 18 is a flowchart of a method for generating interactive video stories based on coarse-grained features and complete fine-grained features on a mobile phone, according to an embodiment of the present disclosure.

### DETAILED DESCRIPTION

The technical solutions of the embodiments of the present disclosure will be clearly and thoroughly described hereinafter in combination with the accompanying drawings. Apparently, the embodiments described herein are merely part of the embodiments of the present disclosure, but not all of the embodiments. Based on the embodiments in the present disclosure, all other embodiments obtained by a person skilled in the art without making creative efforts are within the scope of protection of the present disclosure.

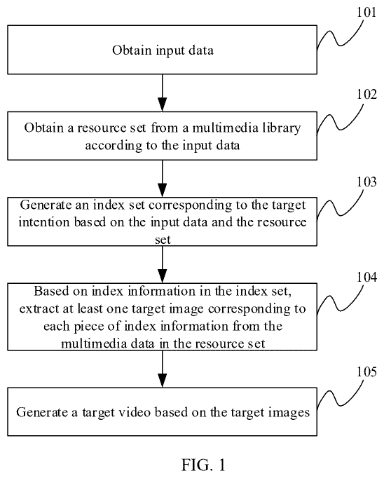

FIG. 1 is A flowchart illustrating an implementation of a video processing method according to an embodiment of the present disclosure. This method may be applied to electronic devices capable of data processing, such as mobile phones, tablet devices, laptops, servers, etc. The technical solution in the disclosed embodiment is mainly to reduce the complexity of user operations when generating videos, thereby improving the user experience.

Specifically, the method in the illustrated embodiment may include the following process.

Step 101: Obtain input data.

The input data indicates a user's target intention to generate a video.

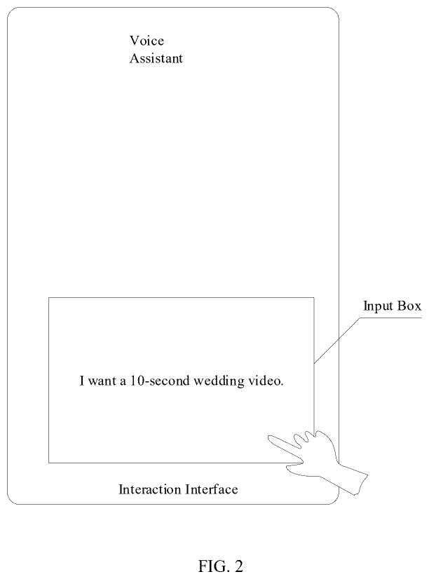

Specifically, in the disclosed embodiment, an interactive interface may be provided to a user through an interactive engine, such as a voice assistant in an electronic device. As shown in FIG. 2, the user may input content in the input box in the interactive interface. Thus, in the disclosed embodiment, the user's input data may be obtained. The obtained input data indicates the user's target intention, and the target intention indicates an intention to generate a video.

For example, if the input data is “I want a 10-second wedding video”, the indicated target intention is to generate a 10-second wedding video. For another example, if the input data is “I want a 20-second team-building activity”, the indicated target intention is to generate a 20-second team-building activity video.

It should be noted that the input data may include data of at least one data type. The data type may include at least one of a voice type and a text type. For example, the input data may be a voice message “I want a 10-second wedding video,” or a text message “I want a 20-second team-building activity.”

Step 102: Obtain a resource set from a multimedia library according to the input data.

The resource set includes at least one multimedia data, and the multimedia data includes at least one of the following: image-type data or video-type data.

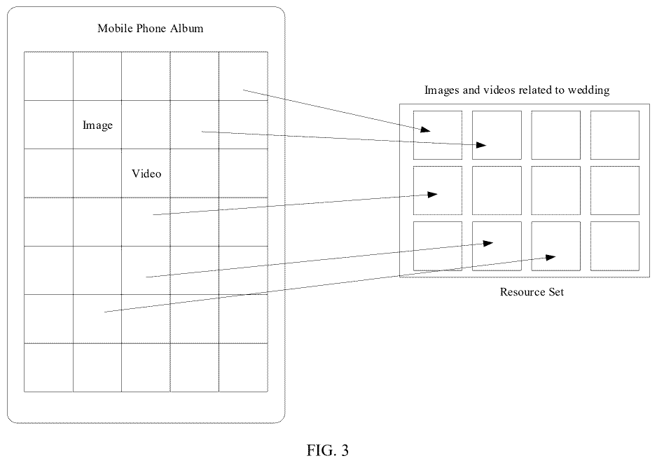

For example, taking a mobile phone as an example, the multimedia library is a mobile phone album, which contains multiple images or videos. Based on this, in the disclosed embodiment, according to the user's input data “I want a 10-second wedding video”, images or videos matching “wedding” are obtained from the mobile phone album to obtain a resource set, that is, a collection of all images or videos related to “wedding” in the mobile phone album or a collection of images or videos related to “wedding” in the past week in the mobile phone album, as shown in FIG. 3.

In one embodiment, in step 102, the input data may be first parsed to obtain at least one associated feature. Then, a fourth processing model may be used to filter out at least one multimedia data from the multimedia library according to the associated features to obtain the resource set.

The associated features include one or more of time, person, and location. For example, parsing the input data “I want a 10-second wedding video” yields the keywords “10 seconds” and “wedding”. Based on these keywords, the associated features are obtained, such as “bride,” “groom,” “bridesmaid,” “groomsman,” “wedding hall,” “wedding candles,” and “wedding photos”.

Specifically, the fourth processing model may be a multimodal visual language model. The trained visual language model may process the input-associated features and multimedia library to output multimedia data that matches the associated features filtered from the multimedia library. These filtered multimedia data constitute the resource set. Based on this, the multimedia data in the resource set are associated with each other based on the associated features.

For example, the visual language model selects images or videos in the mobile phone album that match the associated features such as “bride”, “groom”, “bridesmaid”, “groomsman”, “wedding hall”, “wedding candles”, and “wedding photos”, thereby obtaining associated images or videos in the mobile phone album that match the input data “I want a 10-second wedding video”. These images and videos are associated with each other based on the associated features corresponding to “wedding”.

Step 103: Generate an index set corresponding to the target intention based on the input data and the resource set.

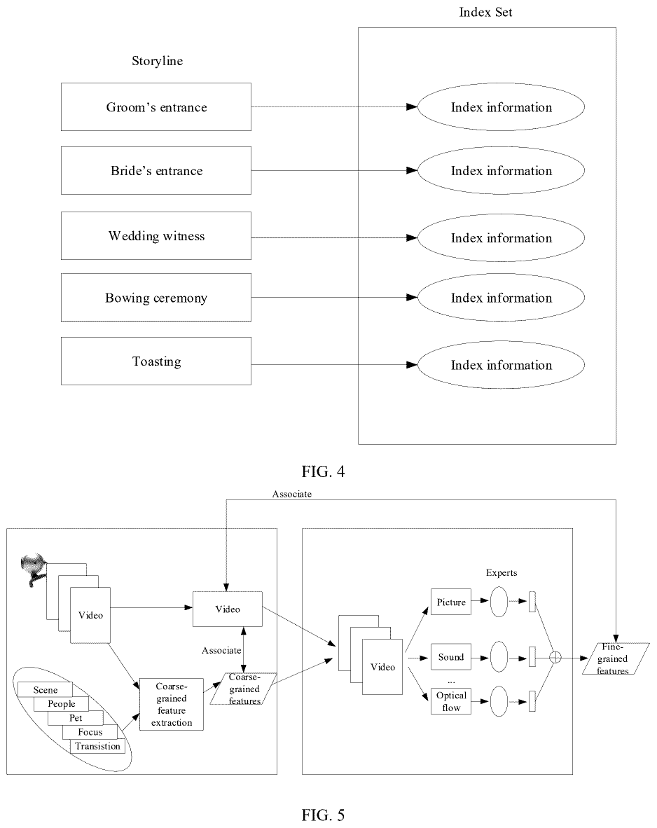

The index set contains at least one piece of index information. The index information in the index set represents the story logic that matches the target intention. For example, the index set contains index information corresponding to storylines such as “groom's entrance,” “bride's entrance,” “wedding witness,” “bowing ceremony,” and “toasting”. As shown in FIG. 4, the story logic represented by this index information is the process of hosting a wedding ceremony. This story logic matches the target intention to generate a 10-second wedding video.

Specifically, in step 103, each multimedia data in the resource set may be parsed, and then, based on the obtained parsing result and the input data, index information matching the target intention may be constructed, that is, an index set may be obtained.

In one embodiment, in step 103, multimedia features corresponding to the multimedia data in the resource set may be first obtained, and then the input data and multimedia features are input into a first processing model to obtain an index set, corresponding to the target intention, output by the first processing model.

The multimedia features may include: coarse-grained features and at least one of the fine-grained features corresponding to the coarse-grained features; fine-grained features include: sub-features of the corresponding coarse-grained features in at least one feature dimension; and feature dimensions may include: at least one of sound, image, and optical flow. For example, coarse-grained features are features of multimedia data in dimensions such as scene, people, pet, focus, and transition; fine-grained features include: sub-features of the corresponding coarse-grained features in dimensions such as image, sound, and optical flow.

It should be noted that the coarse-grained features are obtained during the multimedia data collection process, while the fine-grained features are obtained by extracting the features using a second processing model after the multimedia data is collected. The second processing model may extract corresponding fine-grained features from the multimedia data based on the coarse-grained features.

Specifically, the coarse-grained features may be multimedia features obtained when collecting multimedia data in any image processing scenario. After the multimedia data is collected and stored, the second processing model in the electronic device may extract fine-grained features from the stored multimedia data. It should be noted that after the coarse-grained features are identified, these coarse-grained features are associated with the corresponding multimedia data. After the fine-grained features are extracted, the fine-grained features are also associated with the corresponding multimedia data.

For example, as shown in FIG. 5, in a face recognition scenario, in the process of capturing multiple frames of images or a video composed of multiple video frames through a mobile phone camera, the face of a person within the capture range is identified through a face recognition algorithm or a machine learning model. The facial features obtained through face recognition (or other features related to scene, people, pet, focus, transition, etc.) are coarse-grained features. The coarse-grained features are associated with the corresponding image or video (in MP4 format). Subsequently, a mixture-of-experts model is employed to perform feature extraction on the images or videos associated with coarse-grained features, across feature dimensions such as image, sound, and optical flow, to obtain fine-grained features. The fine-grained features are then associated with the corresponding image or video.

The second processing model may be a mixture-of-experts model, which processes the collected multimedia data and coarse-grained features, thereby extracting fine-grained features more quickly.

In addition, coarse-grained features may be saved in text formats such as JSON, while fine-grained features may be saved in binary formats such as NumPy array (NPY) format.

The first processing model may be a multimodal visual language model. The trained visual language model may process the input data and multimedia features to obtain at least one piece of index information corresponding to the target intention to form an index set.

It should be noted that in the disclosed embodiment, before the fine-grained features are extracted by the mixture-of-experts model, the visual language model may be configured to process just the input data and coarse-grained features to obtain an index set. This may reduce the time consumption caused by waiting for the extraction of fine-grained features, thereby speeding up the efficiency of obtaining the index set and further improving the efficiency of subsequent generation of the target video.

Alternatively, in the disclosed embodiment, when the mixture-of-experts model extracts just some fine-grained features, the visual language model may be configured to process the input data, coarse-grained features, and the extracted portion of fine-grained features to obtain an index set. This allows the generation of an index set based on the input data and coarse-grained features in combination with these fine-grained features, thereby improving the accuracy of the generated index set and thus improving the accuracy of the subsequent generation of the target video. At the same time, it may reduce some of the time consumed by waiting for the extraction of all fine-grained features, thereby speeding up the efficiency of obtaining the index set to a certain extent, and improving the efficiency of subsequent generation of the target video.

Alternatively, in the disclosed embodiment, when the mixture-of-experts model extracts all fine-grained features, the visual language model may be configured to process the input data, the coarse-grained features, and all fine-grained features to obtain an index set. In this way, the index set may be generated based on the input data and coarse-grained features in combination with all fine-grained features, thereby further improving the accuracy of the generated index set and thus improving the accuracy of the subsequent generation of the target video.

Step 104: Based on the index information in the index set, extract at least one target image corresponding to each piece of index information from the multimedia data in the resource set.

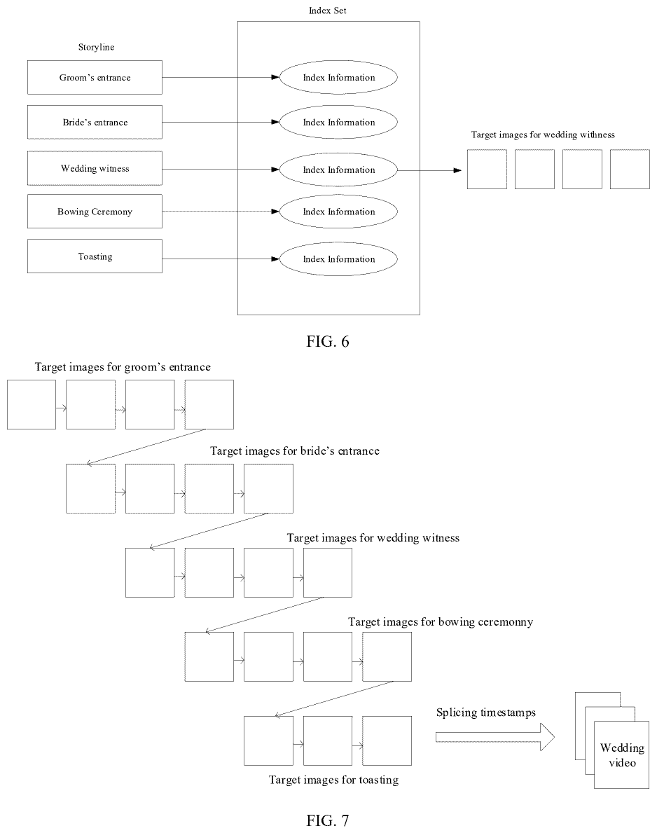

The target image(s) corresponding to each piece of index information may express the corresponding storyline. For example, as shown in FIG. 6, the target image(s) corresponding to the index information corresponding to the storyline of “wedding witness” includes image(s) of the wedding scene. Therefore, the target image(s) corresponding to the index information may express the storyline of “wedding witness”.

For example, in the disclosed embodiment, for each piece of index information, the images corresponding to the index information or partial video segments or video frames in the videos corresponding to the index information may be extracted from all images or videos related to “wedding” screened out of the mobile phone album, to obtain at least one frame of target image corresponding to the index information.

Specifically, the index information at least includes index extraction attributes. The index extraction attributes include an image identification attribute corresponding to the image type, or an extraction timestamp attribute corresponding to the video type. The image identification attribute corresponding to the image type may be an image name or number, such as the image “camera_123456”. The extraction timestamp attribute corresponding to the video type also corresponds to a video identification attribute. The video identification attribute may be a video name or serial number, such as the video “camera 987654”. The corresponding extraction timestamp attribute may represent the timing corresponding to the video frame(s) in a video to which the corresponding video identification attribute belongs, such as the 6-th and 9-th seconds in the video “camera 987654”.

Based on this, in step 104, when extracting the target images, it may be achieved by at least one of the following.

In one embodiment, in step 104, a third processing model may be configured to extract at least one target image corresponding to an image identification attribute, from the image-type multimedia data in the resource set, according to the image identification attribute.

In another embodiment, in step 104, the third processing model may be configured to extract at least one target image with a corresponding timestamp, from the video-type multimedia data in the resource set, according to the extraction timestamp attribute.

The third processing model may be a video editing engine. The video editing engine may extract target images having the same image identification attribute from the resource set according to the image identification attribute. The video editing engine may also extract target images having a corresponding timestamp from video-type multimedia data according to the extraction timestamp attribute.

For example, in the disclosed embodiment, the video editing engine is pre-deployed. The video editing engine may extract images, corresponding to the image identification attributes in the index information, from all images matching “wedding” in the mobile phone album, which are the target images. Moreover, the video editing engine may also intercept video frames, whose timestamps are consistent with the timestamp attributes extracted from the index information, from all videos matching “wedding” in the mobile phone album, such as intercepting the video frames at the 6-th and 9-th seconds of a wedding video clip, which are the target images.

It should be noted that the target images extracted in step 104 have splicing timestamps. The splicing timestamps are determined based on the story logic represented by the index information. For example, a target image corresponding to the index information with an earlier storyline has an earlier splicing timestamp, while a target image corresponding to the index information with a later storyline has a later splicing timestamp.

For example, as shown in FIG. 7, the splicing timestamp of a target image extracted according to the index information corresponding to “bride's entrance” is earlier than the splicing timestamp of a target image extracted according to the index information corresponding to “wedding witness”.

The splicing timestamps of the target images extracted based on the same index information may be determined based on the time the target images were captured. For example, if multiple target images are extracted based on the index information corresponding to “bride's entrance,” the splicing timestamps of these target images may be determined based on the time they were captured by the mobile phone camera.

Step 105: Generate a target video based on the target images.

The stitching timestamps of different target images are different, and there is a timing sequence between the stitching timestamps of each target image. Accordingly, the stitching timestamps may represent the stitching relationship between target images, and the target duration composed of the stitching timestamps matches the target intention.

For example, if the target intention is to generate a 10-second wedding video, then the target duration composed of the spliced timestamps of each target image is “10 seconds”.

Specifically, in step 105, the target images may be stitched together in sequence according to their stitching timestamps to obtain a target video. Based on this, the target video includes video footage of each storyline in the story logic represented by the index information, thereby satisfying the user's target intention to generate a video.

In one embodiment, in step 105, the target images may be input into the third processing model, so that the third processing model performs splicing according to the splicing timestamps to obtain the target video.

For example, as shown in FIG. 7, taking the third processing model as a video editing engine as an example, after extracting the target images, the video editing engine splices these target images according to the splicing timestamps of the target images to obtain a wedding video that matches the target intention to generate a 10-second wedding video.

From the above technical solution, it can be seen that in a video processing method provided by the disclosed embodiment, by obtaining input data indicating a user's target intention to generate a video, a resource set containing multimedia data may be obtained from a multimedia library based on the input data, and then an index set corresponding to the target intention is generated based on the input data and the resource set. In this way, based on the index information in the index set, at least one target image corresponding to each piece of index information is extracted from the multimedia data in the resource set, and finally a target video is generated based on these target images. It can be seen that in the present disclosure, the user just needs to input data indicating the target intention, and the user does not need to perform other operations. According to the user's target intention to generate a video, the corresponding target images may be extracted from the existing multimedia data based on the index information corresponding to the target intention, and the target video may be generated. This may reduce the user's operation complexity and improve the user experience.

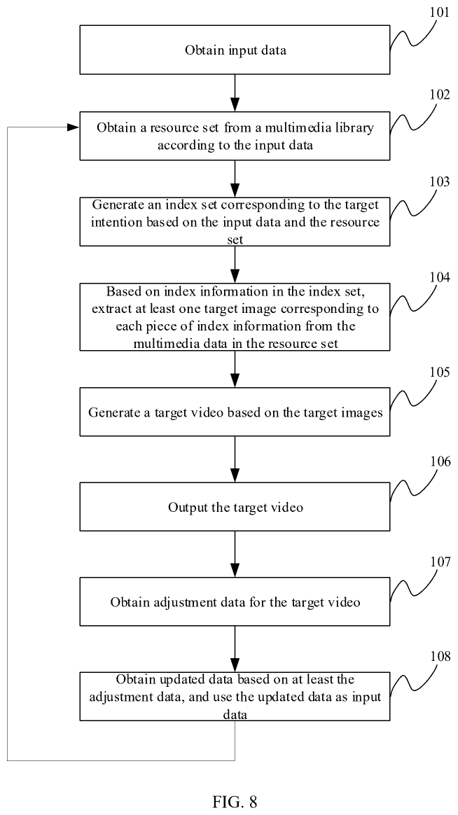

Based on the above implementation scheme, after step 105, the method in the disclosed embodiment may further perform the following processing, as shown in FIG. 8.

Step 106: Output the target video.

In the disclosed embodiment, the target video may be output to the user's interactive interface, so that the user may view the generated target video on the interactive interface, and may also propose corresponding adjustment operations on the target video. Based on this, in the disclosed embodiment, adjustment data for the target video may be generated in response to the adjustment operations.

For example, in the disclosed embodiment, the generated “wedding video” may be output to the user through a video player. If the user is not satisfied with the “wedding video”, the user may modify the input data previously entered on the interactive interface. For example, if the user thinks the video is too long, the initially entered input data “I want to generate a 10-second wedding video” may be modified to “I want to generate a 5-second wedding video”; or, the user may enter new data on the interactive interface, such as “remove the wedding witness part”.

Step 107: Obtain adjustment data for the target video.

The adjustment data indicates the user's intended adjustment to the target video. Specifically, it may include: adjustment data corresponding to the user's modification of the initial input data in the interactive interface, or new data entered by the user in the interactive interface. For example, the data corresponding to the modification operation of changing “10” to “5”; or new data such as “remove the wedding witness part”.

Step 108: Obtain updated data based on at least the adjustment data, and use the updated data as input data, and return the process to step 102 to obtain a resource set from the multimedia library based on the new input data, thereby obtaining a new target video. If the user continues to adjust the target video after outputting the target video, then the above process may be repeated to generate a new target video until the user believes that the generated target video meets the current needs and no additional adjustment operations are needed on the target video.

In the disclosed embodiment, when obtaining the updated data, the input data may be modified according to the adjustment data to obtain the updated data.

For example, in the disclosed embodiment, based on the data corresponding to the modification operation of changing “10” to “5”, the input data “I want to generate a 10-second wedding video” is updated to obtain the updated data “I want to generate a 5-second wedding video”. Then, based on the updated data, the process shown in FIG. 1 is re-executed to generate a new target video, namely a 5-second wedding video.

For example, in the disclosed embodiment, the initial input data “I want to generate a 10-second wedding video” is adjusted according to the new data “remove the wedding witness part” to obtain updated data “I want to generate a 10-second wedding video without the wedding witness part”. Then, based on the updated data, the process shown in FIG. 1 is re-executed to generate a new target video, that is, a 10-second wedding video without the wedding witness part.

In another embodiment of the present disclosure, after obtaining the adjustment data, the adjustment data may be input into the first processing model, and the first processing model outputs a new index set based on the input data, adjustment data and multimedia features. Then, the third processing model is configured to re-extract at least one target image corresponding to each piece of index information from the multimedia data in the resource set based on the index information in the new index set, and then these target images are spliced to generate a new target video.

For example, in the disclosed embodiment, the new data “remove the wedding witness part” is input into the visual language model, and the visual language model outputs a new index set. Then, the video editing engine is used to extract new target images from images or videos related to “wedding” based on the new index set, and then these target images are spliced to generate a new target video, that is, a 10-second wedding video without the wedding witness part.

In another embodiment of the present disclosure, after obtaining the adjustment data, the adjustment data may be input into a third processing model, and the third processing model processes the target images previously extracted from the resource set, such as eliminating part of the target images or extracting new target images from the resource set, etc., and then splicing these target images to generate a new target video.

For example, in the disclosed embodiment, the new data “remove the wedding witness part” is input into the video editing engine, and the video editing engine edits the target images extracted from the images or videos related to the “wedding”, such as deleting the target images related to “wedding witness”, and then splicing the remaining target images to generate a new target video, that is, a 10-second wedding video without the witness segment.

It can be seen that in the disclosed embodiment, interactions with the user may be carried out, and the visual language model and the video editing engine may be configured to generate multiple target videos, so that the generated target video may better meet the needs of the user.

FIG. 9 is a flowchart illustrating an implementation of a video generation method according to an embodiment of the present disclosure. This method may be applied to electronic devices capable of data processing, such as mobile phones, tablet devices, laptops, servers, etc. The technical solution in the disclosed embodiment is primarily used to reduce the complexity of user operations when generating videos, thereby improving the user experience.

Specifically, the method in the disclosed embodiment may include the following process.

Step 901: Obtain input data.

The input data indicates a user's target intention to generate a video.

Specifically, in the disclosed embodiment, an interactive interface may be provided to the user, as shown in FIG. 2, and the user may input content in the input box in the interactive interface. Thus, in the disclosed embodiment, the user's input data may be obtained, and the obtained input data indicates the user's target intention, which indicates an intention to generate a video.

For example, if the input data is “I want a 10-second wedding video”, the indicated target intention is to generate a 10-second wedding video. For another example, if the input data is “I want a 20-second team-building activity”, the indicated target intention is to generate a 20-second team-building activity video.

It should be noted that the input data may include data of at least one data type. The data type may include at least one of a voice type and a text type. For example, the input data may be a voice message “I want a 10-second wedding video”; or a text message “I want a 20-second team-building activity.”

Step 902: Obtain a resource set from a multimedia library according to input data.

The resource set includes at least one multimedia data, and the multimedia data includes at least one of the following: image-type data or video-type data.

For example, taking a mobile phone as an example, the multimedia library is a mobile phone tm, which contains multiple images or videos. Based on this, in the disclosed embodiment, according to the user's input data “I want a 10-second wedding video”, images or videos matching “wedding” are obtained from the mobile phone album to obtain a resource set, that is, a collection of all images or videos related to “wedding” in the mobile phone album or a collection of images or videos related to “wedding” in the past week in the mobile phone album, as shown in FIG. 3.

In one embodiment, in step 902, the input data may be first parsed to obtain at least one associated feature; then, the fourth processing model may be configured to filter out at least one multimedia data from the multimedia library according to the associated features to obtain a resource set.

The associated features include one or more of time, person, and location. For example, parsing the input data “I want a 10-second wedding video” yields the keywords “10 seconds” and “wedding.” Based on these keywords, corresponding associated features are obtained, such as “bride,” “groom,” “bridesmaid,” “groomsman,” “wedding hall,” “wedding candles,” and “wedding photos.”

Specifically, the fourth processing model may be a multimodal visual language model. The trained visual language model may process the input-associated features and multimedia library to output multimedia data that matches the associated features filtered from the multimedia library. These filtered multimedia data constitute the resource set. Based on this, the multimedia data in the resource set are associated with each other based on the associated features.

For example, the visual language model selects images or videos in the mobile phone album that match associated features such as “bride”, “groom”, “bridesmaid”, “groomsman”, “wedding hall”, “wedding candles”, and “wedding photos”, thereby associating images or videos in the mobile phone album that match the input data “I want a 10-second wedding video” based on the associated features corresponding to “wedding”.

Step 903: Process the input data and the resource set based on at least a target model to generate a target video.

The target video contains multiple frames of target images that meet the target intention, and the target images come from at least one of the following situations: multimedia data in the resource set that matches the target intention, such as image-type multimedia data; partial of the multimedia data in the resource set that matches the target intention, such as at least part of the video frames in the video-type multimedia data.

Specifically, the target model may include a visual language model, a video editing engine, a mixture-of-experts model, etc. After training, the target model may process input data and resource set to generate a target video.

For example, first, the visual language model is used to process the input data and multimedia features corresponding to the multimedia data in the resource set to obtain an index set. Then, the video editing engine is used to extract attributes from the index information and extract at least one target image corresponding to each piece of index information from the resource set. The video editing engine then splices these target images according to the splicing timestamps of the target images to obtain the target video.

It should be noted that the specific implementation of step 903 in the disclosed embodiment may refer to the corresponding contents of steps 103 to 105 in the previous descriptions, and will not be described in detail here.

As can be seen from the above technical solution, in a video generation method provided by the disclosed embodiment, by obtaining input data indicating a user's target intention to generate a video, a resource set containing multimedia data may be obtained from a multimedia library based on the input data, and then the input data and the resource set are processed based on the target model to generate a target video. It can be seen that in the present disclosure, the user just needs to input data indicating the target intention, and the user does not need to perform any other operations. The corresponding target images may be extracted from the existing multimedia data according to the user's target intention to generate a video, and the target video may be generated. This may reduce the user's operation complexity and improve the user experience.

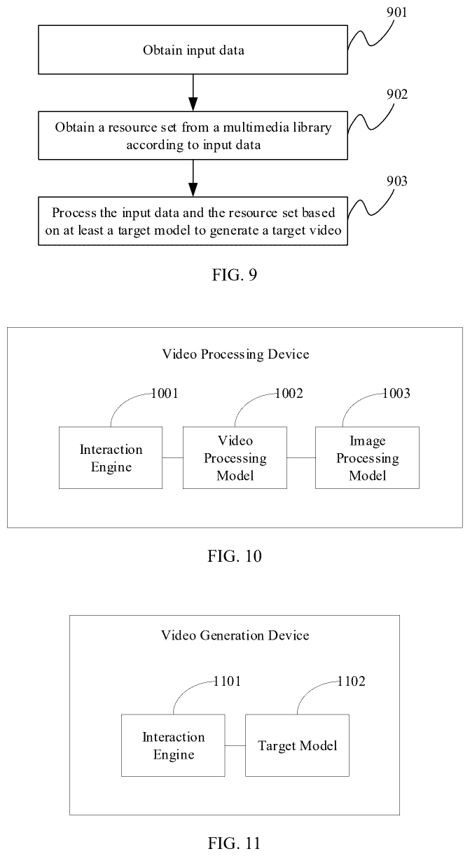

FIG. 10 is a schematic structural diagram of a video processing device according to an embodiment of the present disclosure. This device may be configured in an electronic device capable of data processing, such as a mobile phone, tablet device, laptop, server, etc. The technical solution in the disclosed embodiment is mainly to reduce the complexity of user operations when generating videos, thereby improving the user experience.

Specifically, the device in the disclosed embodiment may include the following units.

An interaction engine 1001, such as a voice assistant, is configured to obtain input data, where the input data indicates the user's target intention to generate a video.

A video processing model 1002, such as a visual language model, is configured to obtain a resource set from a multimedia library based on the input data, the resource set including at least one multimedia data, the multimedia data including at least one of the following types: an image type or a video type; and generate an index set corresponding to the target intention based on the input data and the resource set.

An image processing model 1003, such as a video editing engine, is configured to extract at least one target image corresponding to each piece of index information from the multimedia data in the resource set based on the index information in the index collection; and generate a target video based on the target images.

It can be seen from the above technical solution that in a video processing device provided by the disclosed embodiment, by obtaining input data indicating a user's target intention to generate a video, a resource set containing multimedia data may be obtained from a multimedia library based on the input data, and then an index set corresponding to the target intention is generated based on the input data and the resource set. In this way, based on the index information in the index set, at least one target image corresponding to each piece of index information is extracted from the multimedia data in the resource set, and finally a target video is generated based on these target images. It can be seen that in the disclosed embodiment, the user just needs to input data indicating the target intention, and the user does not need to perform other operations. According to the user's target intention to generate a video, the corresponding target images may be extracted from the existing multimedia data based on the index information corresponding to the target intention, and the target video may be generated. This may reduce the user's operation complexity and improve the user experience.

FIG. 11 is a schematic structural diagram of a video generation device according to an embodiment of the present disclosure. This device may be configured in an electronic device capable of data processing, such as a mobile phone, tablet device, laptop, server, etc. The technical solution in the disclosed embodiment is primarily intended to reduce the complexity of user operations when generating videos, thereby improving the user experience.

Specifically, the device in the disclosed embodiment may include the following units.

An interaction engine 1101, such as a voice assistant, is configured to obtain input data, where the input data indicates a user's target intention to generate a video.

A target model 1102 is configured to obtain a resource set from a multimedia library based on the input data, the resource set including at least one multimedia data, the multimedia data including at least one of the following types: image type or video type; and process the input data and the resource set to generate a target video, the target video including multiple frames of target images that meet the target intention.

The target images are from at least one of the following situations: multimedia data, in the resource set, that matches the target intention; part data, of the multimedia data in the resource set, that matches the target intention.

As can be seen from the above technical solution, in a video generation device provided by the disclosed embodiment of the present disclosure, by obtaining input data indicating a user's target intention to generate a video, a resource set containing multimedia data may be obtained from a multimedia library based on the input data, and then the input data and the resource set are processed based on the target model to generate a target video. It can be seen that in the present disclosure, the user just needs to input data indicating the target intention, and the user does not need to perform any other operations. The corresponding target images may be extracted from the existing multimedia data according to the user's target intention to generate a video, and the target video may be generated. This may reduce the user's operation complexity and improve the user experience.

In one embodiment, after the video editing engine generates a target video based on the target images, the interaction engine is further configured to output the target video, and obtain adjustment data for the target video, where the adjustment data indicates the user's intention to adjust the target video.

Obtain updated data according to at least the adjustment data, and use the updated data as the input data to trigger the visual language model to obtain a resource set from a multimedia library according to the input data.

In one embodiment, when the visual language model generates an index set corresponding to the target intention based on the input data and the resource set, the visual language model is specifically configured to: obtain multimedia features corresponding to the multimedia data in the resource set, the multimedia features including coarse-grained features and at least one of the fine-grained features corresponding to the coarse-grained features, and the fine-grained features including sub-features of the corresponding coarse-grained features on at least one feature dimension; and input the input data and the multimedia features into a first processing model to obtain an index set corresponding to the target intention output by the first processing model, the index set containing at least one index information, where the story logic represented by the index information in the index set matches the target intention.

The coarse-grained features are obtained during the multimedia data collection process. The fine-grained features are obtained by extracting features from the multimedia data using a second processing model after the multimedia data is collected. The second processing model extracts the fine-grained features from the multimedia data based on the coarse-grained features. The feature dimensions include at least one of sound, image, and optical flow. The coarse-grained features are saved in text format, and the fine-grained features are saved in binary format.

In one embodiment, the index information includes at least an index extraction attribute, and the index extraction attributes include an image identification attribute corresponding to an image type or an extraction timestamp attribute corresponding to a video type.

The video editing engine, when extracting at least one target image corresponding to each piece of index information from the multimedia data in the resource set based on the index information in the index set, includes at least one of the following processes.

Use a third processing model to extract at least one target image, corresponding to the image identification attribute from the image-type multimedia data in the resource set, according to the image identification attribute.

Use the third processing model to extract at least one target image with a corresponding timestamp from the video-type multimedia data in the resource set according to the extraction timestamp attribute.

The target images have splicing timestamps, where the splicing timestamps are determined based on the story logic represented by the index information, the splicing timestamps represent the splicing relationship between the target images, and the target duration composed of the splicing timestamps matches the target intention.

In some embodiments, when the video editing engine generates the target video based on the target images, the video editing engine is specifically configured to input the target images into the third processing model, so that the third processing model performs splicing according to the splicing timestamps to obtain the target video.

In one embodiment, when the visual language model obtains a resource set from a multimedia library based on the input data, the visual language model is specifically configured to: parse the input data to obtain at least one associated feature, where the associated features include: at least one of time, person, and location; and utilize a fourth processing model to filter out at least one multimedia data from the multimedia library according to the associated features to obtain a resource set, where the multimedia data in the resource set are associated with each other based on the associated features.

The input data includes data of at least one data type. The data type includes at least one of a voice type and a text type.

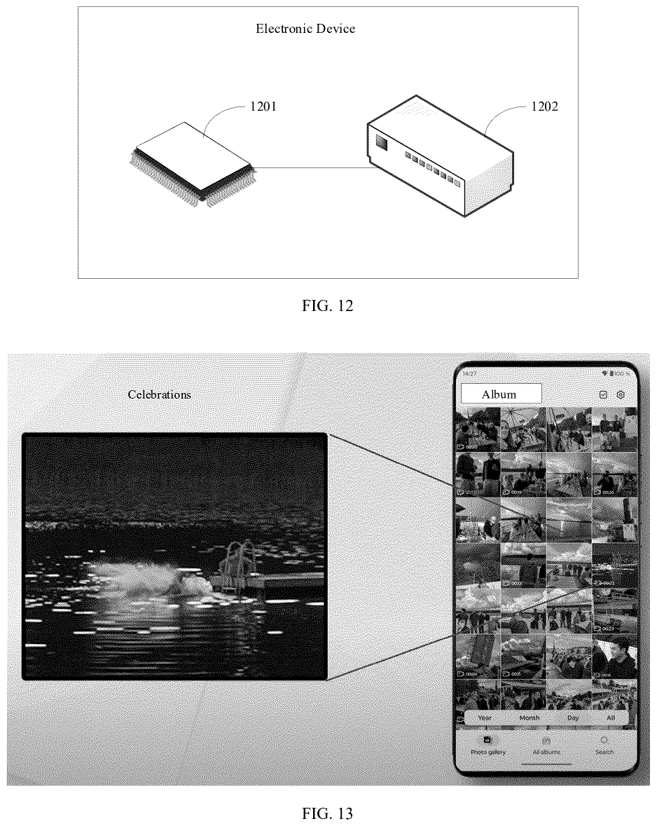

FIG. 12 is a schematic structural diagram of an electronic device according to an embodiment of the present disclosure. The electronic device may include the following structures.

A memory is configured to store computer programs and data generated by the operation of computer programs.

A processor is configured to execute a computer program to implement the video processing method or video generating method described in any of the above embodiments.

Taking a mobile phone as an example, the following is an example of the technical solution of the present disclosure.

As shown in FIG. 13, during celebrations, photographers often capture the day's joyful moments through various angles, positions, and video clips. The result is a collection of video clips in their photo albums, many of which are unsuitable for direct sharing due to their length, volume, and overall reflection of the event.

For this purpose, a personalized “memories” feature in the photo album is currently widely used. This allows users to create a “memories mashup” of photos and videos based on information such as time, people, events, and location, and then play them back in a story-like format with accompanying music and animation. However, this “memories” feature requires a lot of manual operation, especially when exporting and sharing videos.

In view of this, the present disclosure may use modules such as AI voice assistant, multimodal visual language model and AI video editing engine to achieve interaction and quickly edit short videos based on user intentions.

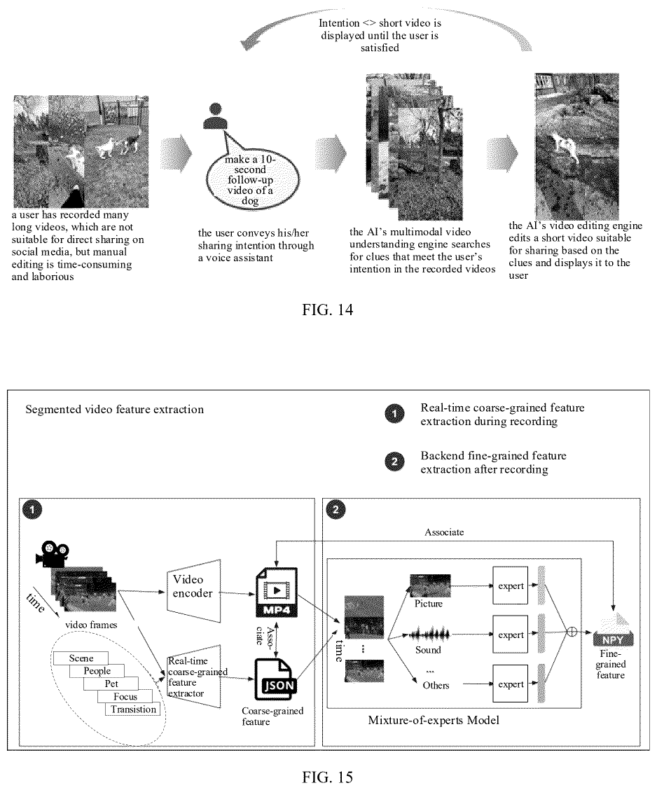

As shown in FIG. 14, a user has recorded many long videos, which are not suitable for direct sharing on social media, but manual editing is time-consuming and laborious. To this end, based on the technical solutions of the present disclosure, the user conveys his/her sharing intention through a voice assistant, such as “make a 10-second follow-up video of a dog”, and then the AI's multimodal video understanding engine, namely the visual language model, searches for clues that meet the user's intention in the recorded videos. Finally, the AI's video editing engine edits a short video suitable for sharing based on the clues and displays it to the user. Afterwards, the user uses the voice assistant to adjust the intention or re-enter the intention based on the displayed short video, and accordingly new clues are searched again, a short video is edited again, and the short video is displayed again until the user is satisfied.

A vision language model (VLM) or vision large language model (VLLM) is a key module for implementing the disclosed functions, as it enables video understanding, summary generation, storyline generation, and interactive dialogue. Video feature extraction (VFRE) is the foundation for VLM/VLLM to achieve these functions and typically requires significant computing power.

In response to the defects of existing visual language models (e.g., existing visual language models all extract video features from scratch during the video consumption stage), the present disclosure fully utilizes the hardware and algorithm capabilities of the video production stage, divides video features into two stages, coarse and fine, and extracts them separately, thereby greatly improving the efficiency of video feature extraction and laying a good foundation for subsequent visual language models to quickly understand videos.

Here, during the video production stage, a camera itself may extract many video features (people/pet/scene/focus/transition, etc.). These video features are used for recording services and are discarded as the recording progresses. In the present disclosure, these features carried in the video are directly used, and there is no need to re-extract these video features, thereby improving the efficiency of video feature extraction.

As shown in FIG. 15, the process of segmented video feature extraction is as follows.

\textcircled{1} Real-time coarse-grained feature extraction during recording; \textcircled{2} Backend fine-grained feature extraction after recording.

Here, multiple video frames are collected by the camera according to time, and a video file (in MP4 format) is generated through the video encoder. In this process, a coarse-grained feature extractor is used to extract coarse-grained features (in JSON format) in dimensions such as scene, people, pet, focus, and transition in real time. The coarse-grained video features are generated and associated with the video files synchronously. The fine-grained video features are analyzed by the backend service calling a mixture-of-experts model, such as analyzing the fine-grained features (in NPY format) in the picture, sound, optical flow and other dimensions. With the input of coarse-grained video features, the mixture-of-experts model may complete the extraction of fine-grained video features more quickly. The fine-grained features are extracted and then associated with the video files.

If a user's requirement for video editing is to start right after the video is recorded, then the fine-grained features may not have been extracted yet, or may have been only partially extracted. Therefore, in the disclosed embodiment, interactive video editing is divided into the following three situations based on the extraction status of fine-grained features.

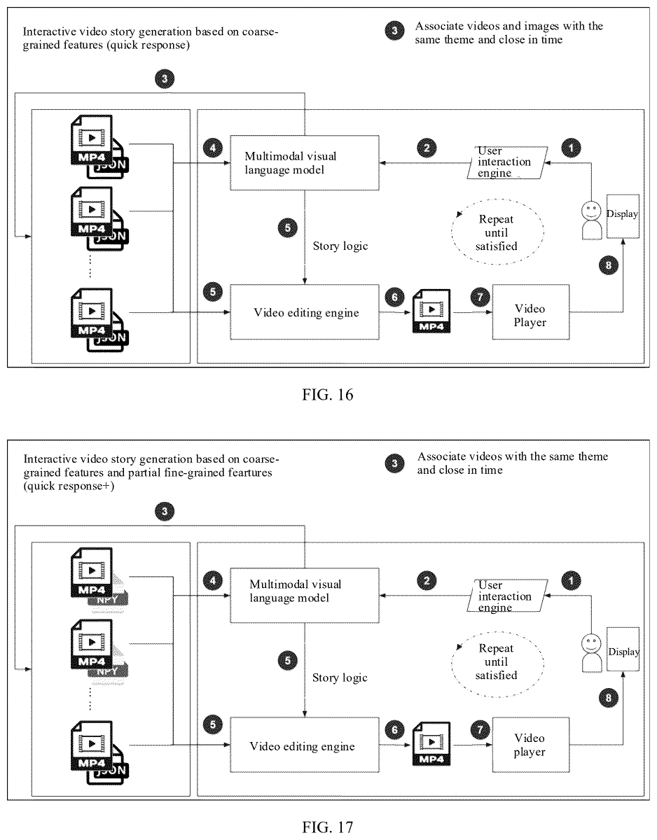

FIG. 16 shows a flowchart of a method for interactive video story generation based on coarse-grained features. If fine-grained features have not yet been extracted from the videos or images in the resource set, then the coarse-grained features in the videos or images may be used to achieve a quick response, thereby enabling rapid video generation. However, the generated video may deviate from the user's intention. The specific process is as follows.

\textcircled{1} The user enters data on the screen to indicate the user's intention.

\textcircled{2} The user interaction engine obtains the user's input data and sends it to the multimodal visual language model.

\textcircled{3} The visual language model selects images or videos that match the intention from the album based on the input data, and then associates videos or images, with the same theme, that are close in time to form a resource set.

\textcircled{4} Provide the resource set to the multimodal visual language model, which constructs story logic based on the coarse-grained features (in JSON format) of the images or videos in the resource set.

\textcircled{5} Provide the resource set to the video editing engine, and at the same time, provide the story logic to the video editing engine, that is, the index information mentioned above.

\textcircled{6} The video editing engine extracts the target images based on the index information and generates the target video (in MP4 format).

\textcircled{7} Send the target video to the video player.

\textcircled{8} The video player outputs the target video to the screen so that the user may make modification suggestions for the target video, and returns to \textcircled{1} to regenerate the target video, and this cycle may repeat until the user is satisfied.

FIG. 17 is a flowchart of a method for interactive video story generation based on coarse-grained features combined with some fine-grained features. If the videos or images in the resource set have begun fine-grained feature extraction but has not yet completed fine-grained feature extraction, then the coarse-grained features and some fine-grained features in the videos or images may be used to achieve a rapid response, thereby achieving rapid video generation. The generated video is closer to the user's intention than the video generated by the process shown in FIG. 15. The specific process is as follows.

\textcircled{1} The user enters data on the screen to indicate the user's intention.

\textcircled{2} The user interaction engine obtains the user's input data and sends it to the multimodal visual language model.

\textcircled{3} The visual language model selects images or videos that match the intention from the album based on the input data, and then associates videos or images with the same theme that are close in time to form a resource set.

\textcircled{4} Provide the resource set to the multimodal visual language model, which constructs story logic based on the coarse-grained features (in JSON format) and some fine-grained features (in NPY format) of the images or videos in the resource set.

\textcircled{5} Provide the resource set to the video editing engine, and at the same time, provide the story logic to the video editing engine, that is, the index information mentioned above.

\textcircled{6} The video editing engine extracts the target images based on the index information and generates the target video (in MP4 format).

\textcircled{7} Send the target video to the video player.

\textcircled{8} The video player outputs the target video to the screen so that the user may make modification suggestions for the target video, and returns to \textcircled{1} to regenerate the target video, and this cycle may repeat until the user is satisfied.

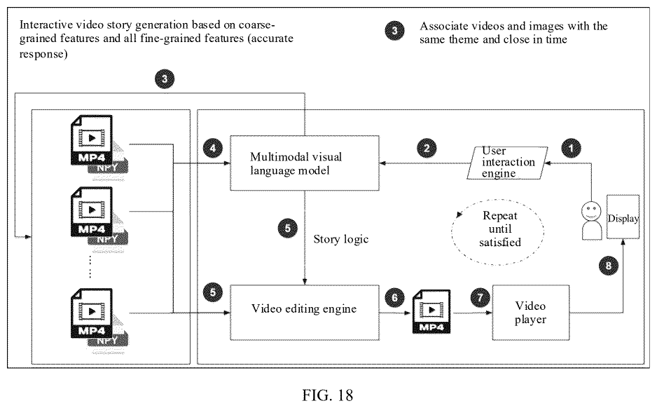

FIG. 18 is a flowchart of a method for interactive video story generation based on coarse-grained features and complete fine-grained features. If the extraction of fine-grained features has already begun and completed for the videos or images in the resource set, then the coarse-grained features and complete fine-grained features in the videos or images may be used to achieve accurate responses, thereby achieving video generation while ensuring that the generated video is more accurate, that is, the generated video matches well the user's intention. The specific process is as follows.

\textcircled{1} The user enters data on the screen to indicate the user's intention.

\textcircled{2} The user interaction engine obtains the user's input data and sends it to the multimodal visual language model.

\textcircled{3} The visual language model selects images or videos that match the intention from the album based on the input data, and then associates videos or images with the same theme that are close in time to form a resource set.

\textcircled{4} Provide the resource set to the multimodal visual language model, which constructs story logic based on the complete fine-grained features (in NPY format) of the images or videos in the resource set (which may also include coarse-grained features (in JSON format)).

\textcircled{5} Provide the resource set to the video editing engine, and at the same time, provide the story logic to the video editing engine, that is, the index information mentioned above.

\textcircled{6} The video editing engine extracts the target images based on the index information and generates the target video (in MP4 format).

\textcircled{7} Send the target video to the video player.

\textcircled{8} The video player outputs the target video to the screen so that the user may make modification suggestions for the target video, and returns to \textcircled{1} to regenerate the target video, and this cycle may repeat until the user is satisfied.

The various embodiments in this specification are described in a progressive manner, with each embodiment focusing on the differences from other embodiments. Reference may be made to the shared and similar parts between the various embodiments. For the devices disclosed in the embodiments, since they correspond to the methods disclosed in the embodiments, the description is relatively simple, and the relevant parts may be referred to the descriptions of the method embodiments.

An artisan may further appreciate that the units and algorithm steps of each example described in conjunction with the embodiments disclosed herein may be implemented in electronic hardware, computer software, or a combination thereof. In order to clearly illustrate the interchangeability of hardware and software, the above descriptions have generally covered the components and steps of each embodiment according to their functions. Whether these functions are performed in hardware or software depends on the specific application and design constraints of the technical solutions. A person skilled in the art may use different methods to implement the described functions for each specific application, but such implementation should not be considered beyond the scope of the present disclosure.

The steps of the methods or algorithms described in conjunction with the embodiments disclosed herein may be implemented directly using hardware, software modules executed by a processor, or a combination thereof. The software modules may be placed in random access memory (RAM), internal memory, read-only memory (ROM), electrically programmable ROM, electrically erasable programmable ROM, registers, a hard disk, a removable disk, a CD-ROM, or any other form of storage medium known in the art.

The above descriptions of the disclosed embodiments are intended to enable one skilled in the art to implement or use the present disclosure. Various modifications to these embodiments will be readily apparent to one skilled in the art, and the general principles defined herein may be implemented in other embodiments without departing from the spirit or scope of the present disclosure. Accordingly, the present disclosure is not limited to the embodiments described herein, but is intended to conform to the widest scope consistent with the principles and novel features disclosed herein.

It is claimed is:

1. A video processing method, comprising:
obtaining input data, the input data indicating a user's target intention to generate a video;
obtaining a resource set from a multimedia library according to the input data, wherein the resource set includes at least one multimedia data, and the multimedia data includes at least one of following types: an image type or a video type;
generating an index set corresponding to the target intention based on the input data and the resource set;
extracting at least one target image corresponding to each piece of index information from the multimedia data in the resource set based on index information in the index set; and
generating a target video based on target images.

2. The method according to claim 1, further comprising:
after generating the target video based on the target images, outputting the target video;
obtaining adjustment data for the target video, wherein the adjustment data indicates a user's intention to adjust the target video; and
obtaining updated data according to at least the adjustment data, and using the updated data as the input data, and returning to a process of obtaining the resource set from the multimedia library according to the input data.

3. The method according to claim 1, wherein generating the index set corresponding to the target intention based on the input data and the resource set comprises:
obtaining multimedia features corresponding to the multimedia data in the resource set, the multimedia features including a coarse-grained feature and at least one fine-grained feature corresponding to the coarse-grained feature, the fine-grained feature including a sub-feature of the corresponding coarse-grained feature in at least one feature dimension; and
inputting the input data and the multimedia features into a first processing model to obtain the index set corresponding to the target intention output by the first processing model, wherein the index set includes at least one piece of index information,
wherein a story logic represented by the index information in the index set matches the target intention.

4. The method according to claim 3, wherein:
the coarse-grained feature is obtained during a process of collecting the multimedia data;
the fine-grained feature is obtained by extracting features using a second processing model after the multimedia data is collected, wherein the second processing model extracts the fine-grained feature from the multimedia data based on the coarse-grained feature; and
the at least one feature dimension includes at least one of sound, picture and optical flow.

5. The method according to claim 3, wherein the coarse-grained feature is saved in a text format, and the fine-grained feature is saved in a binary format.

6. The method according to claim 1, wherein:
the index information includes at least one index extraction attribute, the at least one index extraction attribute including an image identification attribute corresponding to the image type or an extraction timestamp attribute corresponding to the video type; and
extracting the at least one target image corresponding to each piece of index information from the multimedia data in the resource set based on the index information in the index set includes at least one of following:
using a third processing model to extract at least one target image corresponding to the image identification attribute from image-type multimedia data in the resource set according to the image identification attribute; and
using the third processing model to extract at least one target image with a corresponding timestamp from video-type multimedia data in the resource set according to the extraction timestamp attribute.

7. The method according to claim 6, wherein:
the target images have splicing timestamps, the splicing timestamps being determined based on a story logic represented by the index information, the splicing timestamps representing a splicing relationship between the target images, and a target duration composed of the splicing timestamps matching the target intention; and
generating the target video based on the target images includes:
inputting the target images into the third processing model so that the third processing model performs splicing according to the splicing timestamps to obtain the target video.

8. A video generation method, comprising:
obtaining input data, the input data indicating a user's target intention to generate a video;
obtaining a resource set from a multimedia library according to the input data, wherein the resource set includes at least one multimedia data, and the multimedia data includes at least one of the following types: an image type or a video type; and
processing the input data and the resource set based at least on a target model to generate a target video, wherein the target video includes multiple frames of target images that meet the target intention, and the target images are derived from at least one of the following:
multimedia data, in the resource set, that matches the target intention, or
partial data, in the multimedia data in the resource set, that matches the target intention.

9. The method according to claim 8, further comprising:
after generating the target video, outputting the target video;
obtaining adjustment data for the target video, wherein the adjustment data indicates a user's intention to adjust the target video; and
obtaining updated data according to at least the adjustment data, and using the updated data as the input data, and returning to a process of obtaining the resource set from the multimedia library according to the input data.

10. The method according to claim 8, further comprising:
obtaining multimedia features corresponding to the multimedia data in the resource set, the multimedia features including a coarse-grained feature and at least one fine-grained feature corresponding to the coarse-grained feature, the fine-grained feature including a sub-feature of the corresponding coarse-grained feature in at least one feature dimension; and
inputting the input data and the multimedia features into a first processing model to obtain an index set corresponding to the target intention output by the first processing model, wherein the index set includes at least one piece of index information,
wherein a story logic represented by the index information in the index set matches the target intention.

11. The method according to claim 10, wherein:
the coarse-grained feature is obtained during a process of collecting the multimedia data;
the fine-grained feature is obtained by extracting features using a second processing model after the multimedia data is collected, wherein the second processing model extracts the fine-grained feature from the multimedia data based on the coarse-grained feature; and
the at least one feature dimension includes at least one of sound, picture and optical flow.

12. The method according to claim 10, wherein the coarse-grained feature is saved in a text format; and the fine-grained feature is saved in a binary format.

13. The method according to claim 10, wherein:
the index information includes at least one index extraction attribute, the at least one index extraction attribute including an image identification attribute corresponding to the image type or an extraction timestamp attribute corresponding to the video type; and
extracting at least one target image corresponding to each piece of index information from the multimedia data in the resource set based on the index information in the index set includes at least one of the following:
using a third processing model to extract at least one target image corresponding to the image identification attribute from image-type multimedia data in the resource set according to the image identification attribute; and
using the third processing model to extract at least one target image with a corresponding timestamp from video-type multimedia data in the resource set according to the extraction timestamp attribute

14. An electronic device, comprising one or more processors and a memory containing a computer program that, when being executable, causes the one or more processors to perform:
obtaining input data, the input data indicating a user's target intention to generate a video;
obtaining a resource set from a multimedia library according to the input data, wherein the resource set includes at least one multimedia data, and the multimedia data includes at least one of following types: an image type or a video type;
generating an index set corresponding to the target intention based on the input data and the resource set;
extracting at least one target image corresponding to each piece of index information from the multimedia data in the resource set based on the index information in the index set; and
generating a target video based on target images.

15. The electronic device according to claim 14, wherein the one or more processors are further configured to perform:
after generating the target video based on the target images, outputting the target video;
obtaining adjustment data for the target video, wherein the adjustment data indicates a user's intention to adjust the target video; and
obtaining updated data according to at least the adjustment data, and using the updated as the input data, and returning to a process of obtaining the resource set from the multimedia library according to the input data.

16. The electronic device according to claim 14, wherein the one or more processors are further configured to perform:
obtaining multimedia features corresponding to the multimedia data in the resource set, the multimedia features including a coarse-grained feature and at least one fine-grained feature corresponding to the coarse-grained feature, the fine-grained feature including a sub-feature of the corresponding coarse-grained feature in at least one feature dimension; and
inputting the input data and the multimedia features into a first processing model to obtain the index set corresponding to the target intention output by the first processing model, wherein the index set includes at least one piece of index information,
wherein a story logic represented by the index information in the index set matches the target intention.

17. The electronic device according to claim 16, wherein:
the coarse-grained feature is obtained during a process of collecting the multimedia data;
the fine-grained feature is obtained by extracting features using a second processing model after the multimedia data is collected, wherein the second processing model extracts the fine-grained feature from the multimedia data based on the coarse-grained feature; and
the at least one feature dimension includes at least one of sound, picture and optical flow.

18. The electronic device according to claim 16, wherein the coarse-grained feature is saved in a text format; and the fine-grained feature is saved in a binary format.

19. The electronic device according to claim 14, wherein:
the index information includes at least one index extraction attribute, the at least one index extraction attribute including an image identification attribute corresponding to the image type or an extraction timestamp attribute corresponding to the video type; and
extracting the at least one target image corresponding to each piece of index information from the multimedia data in the resource set based on the index information in the index set includes at least one of following:
using a third processing model to extract at least one target image corresponding to the image identification attribute from image-type multimedia data in the resource set according to the image identification attribute; and
using the third processing model to extract at least one target image with a corresponding timestamp from the video-type multimedia data in the resource set according to the extraction timestamp attribute.

20. The electronic device according to claim 19, wherein:
the target images have splicing timestamps, the splicing timestamps being determined based on a story logic represented by the index information, the splicing timestamps representing a splicing relationship between the target images, and a target duration composed of the splicing timestamps matching the target intention; and
the one or more processors are further configured to perform:
inputting the target images into the third processing model so that the third processing model performs splicing according to the splicing timestamps to obtain the target video.
